(19) United States
(12) Patent Application Publication
(10) Pub. No.: US 2004/0190735 A1
(43) Pub. Date: Sep. 30, 2004

(54) Acoustic interactive counter display

(76) Inventor: Christopher G. Gauss, Linden, MI (US)

Correspondence Address: Gordon K. Harris, Harness, Dickey & Pierce P.L.C., P.O. Box 828, Bloomfield Hills, MI, 48303, US

(21) Appl. No.: 10/402,332

(22) Filed: Mar. 28, 2003

(51) Int. Cl. H02B 1/00

(52) U.S. Cl. 381/123

(57) ABSTRACT

An acoustic countertop display comprises a housing adapted to sit on a countertop and a controller mounted within the housing. The controller stores a plurality of prerecorded sounds. The housing further includes a plurality of input devices mounted on a surface of the housing. The input devices are in communication with the controller, and each input device is associated with one of the plurality of prerecorded sounds. A speaker is mounted within the housing and is in communication with the controller. Actuation of one of the plurality of input devices by a user orders the controller to send one of the prerecorded sounds associated with the actuated input device to the speaker. The speaker then emits the prerecorded sound to the user.

### FIELD OF THE INVENTION

The present invention relates to an acoustic interactive counter display and more particularly to an acoustic interactive counter display for comparing the exhaust acoustics of various mufflers.

### BACKGROUND OF THE INVENTION

Within sales and advertising, the acoustical properties of a product can be difficult to quantify and describe. And yet these acoustical properties can be an important factor in the decision making process of a consumer when contemplating a purchase. Moreover, it is often impractical for the acoustics of a product to be demonstrated by producing the product and illustrating its acoustics for a consumer.

For example, mufflers are an important piece of equipment on an automobile or other motor vehicle. Not only do the mufflers directly affect the performance of a vehicle, they are primarily responsible for controlling the acoustics of the engine exhaust. An important and growing industry exists in selling component add-on mufflers to replace the as equipped standard mufflers found on a motor vehicle. Within this industry, it is extremely important for a potential buyer to be able to compare the acoustics of an add-on replacement muffler with the acoustics of the as equipped muffler found on the buyer's motor vehicle. Short of installing the add-on muffler to the buyer's motor vehicle, or alternatively producing a motor vehicle of the same type and manufacture having the add-on muffler, there is no practical way to accurately and easily inform the buyer of the add-on muffler's acoustical properties.

Accordingly, there is a need in the art to provide a portable and convenient counter top display that is capable of easily and accurately reproducing selected sounds for comparison purposes.

### SUMMARY OF THE INVENTION

An acoustic countertop display is provided. The display comprises a housing adapted to sit on a countertop and a controller mounted within the housing. The controller stores a plurality of prerecorded sounds. The housing further includes a plurality of input devices mounted on a surface of the housing. The input devices are in communication with the controller, and each input device is associated with one of the plurality of prerecorded sounds. A speaker is mounted within the housing and is in communication with the controller. Engagement of one of the plurality of input devices by a user orders the controller to send one of the prerecorded sounds associated with the engaged input device to the speaker. The speaker then emits the prerecorded sound to the user.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of an acoustic interactive counter display constructed in accordance with the principles of the present invention shown in an environmental setting with a generic user;

FIG. 2 is a front perspective view of the acoustic interactive counter display;

FIG. 3 is a back perspective view of the acoustic interactive counter display;

FIG. 4 is a bottom view of the acoustic interactive counter display; and

FIG. 5 is a schematic view of the electronic control system of the acoustic interactive counter display.

### DETAILED DESCRIPTION

The following description is merely exemplary in nature and is in no way intended to limit the invention, its application, or uses.

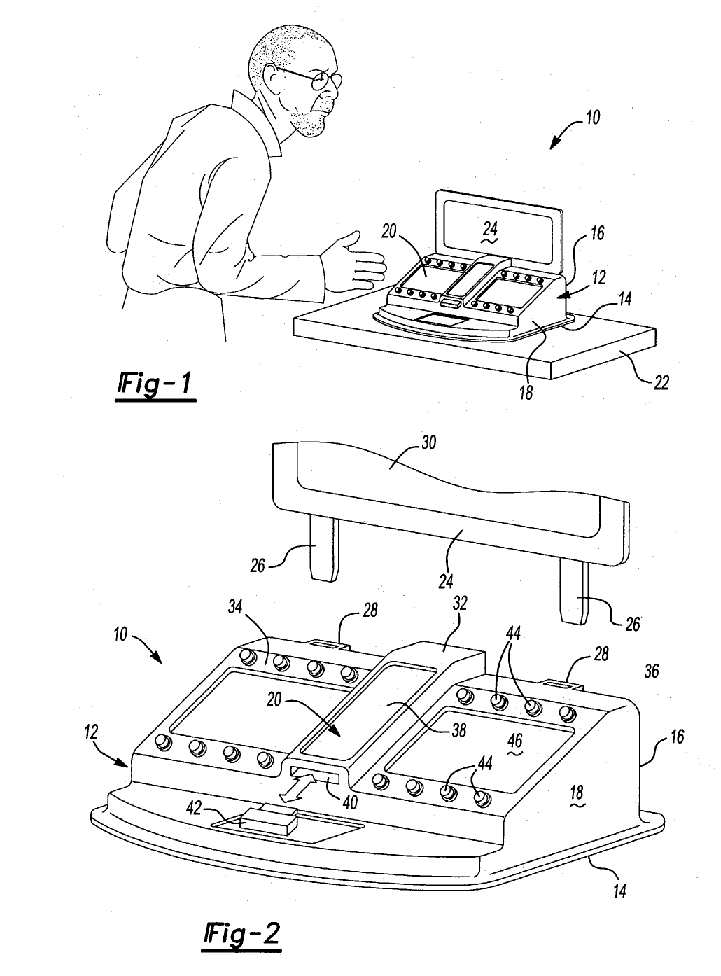

With reference to FIGS. 1 and 2 of the drawings, an acoustic interactive counter display that is constructed in accordance with the teachings of the present invention is generally indicated by reference numeral 10. The display 10 includes a body 12 having a base 14, a back wall 16, side walls 18, and a sloped front face 20. Preferably, the body 12 is constructed as a unitary piece, for example molded plastic. However, various other methods of construction may be employed and various materials used without departing from the scope of the invention.

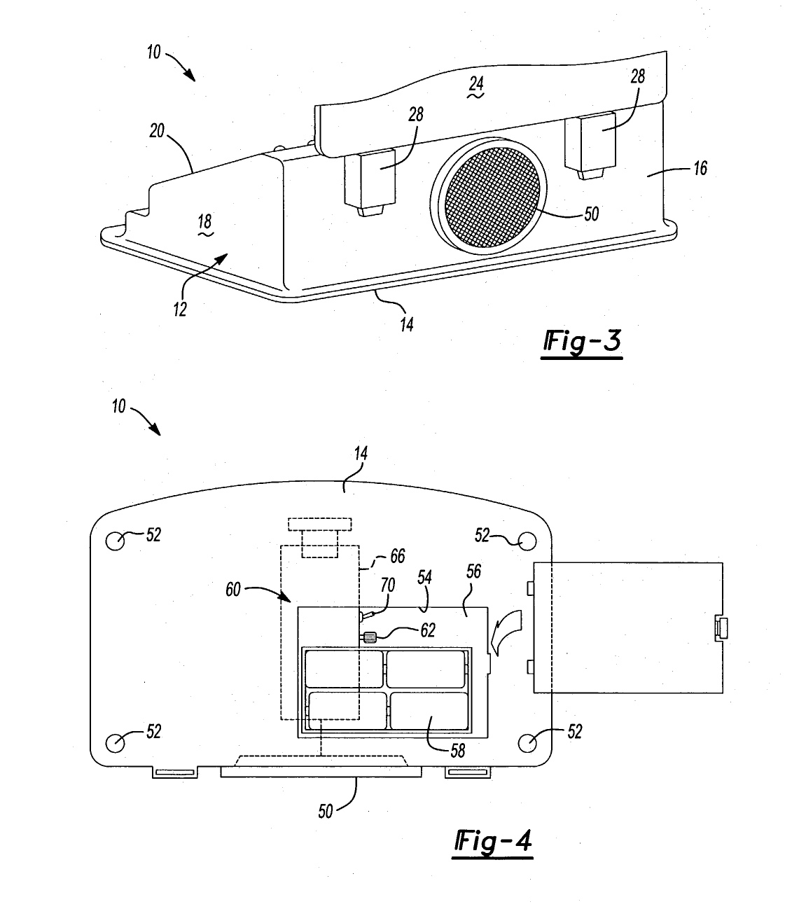

The display 10 is designed to sit atop a countertop, indicated by reference numeral 22. However, various other locations and uses for the display 10 may be employed. Preferably, an upright sign 24 may be removably fixed to the body 12 of the display 10. As best seen in FIG. 3, the upright sign 24 includes tabs 26 that releasably engage slots 28 formed on the back wall 16 of the body 12. However, various other methods of securing the upright sign 24 to the body 12 may be employed, for example adhesives, fasteners, or screws. The upright sign 24 has a surface 30 facing towards the user for displaying information, for example a set of instructions or a product list.

The front face 20 is angled with respect to the base 14 in order to provide clear viewing and easy access by the user. The front face 20 includes a centerpiece 32 and a left portion 34 and a right portion 36. The left and right portions 34, 36 are substantially symmetrical, therefore only the right portion 36 will be described in detail, it being understood that the detailed description provided below applies equally to the left portion 34.

The centerpiece 32 is raised from the surface of the front face 20 and is generally rectangular in shape for reasons that will be described in greater detail below. The centerpiece 32 includes a flat recessed surface 38 for receiving an information display, for example an advertisement sticker or a set of instructions. Preferably the information display is secured to the centerpiece 32 by an adhesive, however, the information display may alternatively be removably secured by tabs or other appropriate means.

In the particular example provided, a slot 40 is formed on the lower edge of the centerpiece 32 for receiving a Permanent Read-Only Memory card 42 (hereinafter PROM card 42). However, the slot 40 may be formed anywhere on the centerpiece 32 so long as it provides access to the interior of the body 12. The PROM card 42 contains digital sound information as will be described in greater detail below. Alternatively, the digital sound information can be stored permanently within the display 10 on a circuit chip or other suitable means.

The right portion 36 includes a first row of input devices 44 and a second row of input devices 44. In the particular example provided, input devices 44 are push-button switches as are well known in the art. However, various other input devices 44 may be employed, including a touch screen, flip switches, or dials. The right portion 36 further includes a recessed area 46 formed between the first row of input devices 44 and the second row of input devices 44. The recessed area 46 extends parallel to the first and second rows of input devices 44 and is shaped to receive an information card. The information card may be adhesively or removably attached to the recessed area 46 and provides information as to the assigned function of each input device 44.

As best seen in FIG. 3, the back wall 16 supports a speaker 50. The speaker 50 is mounted approximately centrally on the back wall 16. The speaker 50 may be any conventional speaker capable of receiving an electronic signal and emitting an acoustic signal for a user to hear.

Referring now to FIG. 4, the base 14 is flat for resting on the countertop 22. Rubber knobs 52 fixed at the corners of the base 14 provide a non-slippery contact between the countertop 22 and the display 12. The base 14 includes an opening 54 that provides access to the interior 56 of the body 12. The interior 56 of the body 12 houses a power source 58, an electrical control system 60, a volume control 62, and a portion of the speaker 50. The power source 58 is illustrated to include a plurality of conventional alkaline batteries, but alternatively may include any conventional form of power. The volume control 62 is easily graspable by the user through the opening 54 and controls the volume of the speaker 50.

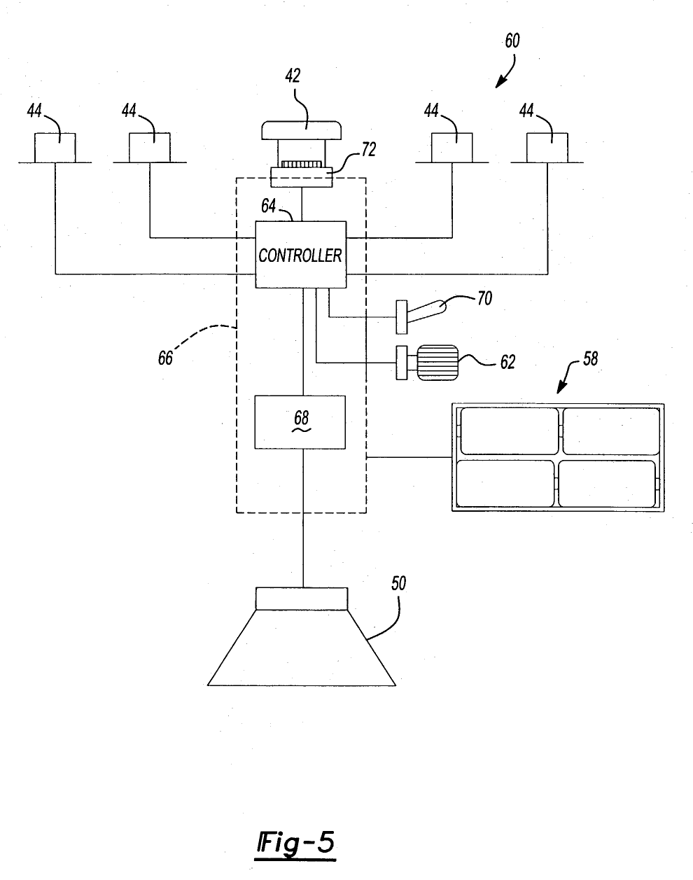

Referring now to FIG. 5, the electrical control system 60 will now be described. The electrical control system 60 includes a controller 64 mounted on a circuit board 66. The controller 64 is in electronic communication with the plurality of input devices 44, the speaker 50, the power source 58, the volume control 62, as well as a signal amplification chip 68, an on/off switch 70, and a PROM card receiver 72. The controller 64 is a circuit chip capable of interpreting signals from the plurality of input devices 44 and sending a signal through the signal amplification chip 68 to the speaker 50. The circuit board 66 is mounted within the interior 56 of the body 12 underneath the centerpiece 32. To this end, the centerpiece 32 has a size and shape adapted to receive the circuit board 66.

Insertion of a PROM card 42 into the PROM card receiver 72 allows the controller 64 to assign the digital information stored on the PROM card 42 to the plurality of input devices 44. The PROM card 42 preferably stores the digital audio recordings of various mufflers mounted on a given vehicle type. For example, the audio recordings of a car having its standard as equipped muffler is recorded and stored on the PROM card 42. The audio recordings of various other mufflers mounted on the same car type, such as an Ultra Flo Stainless Kit, a Super Turbo Kit, Ultra Flo Stainless Muffler, or a Ultra Flo Welded Muffler, all manufactured by the assignee, are then also stored on the PROM card 42. As many audio recordings as there are input devices 44 may be stored on any given PROM card 42.

Preferably, each individual sound recording includes a free rev portion and an acceleration portion. During the free rev portion, the muffler exhaust acoustics of the vehicle are recorded while the vehicle is stationary and the engine is revved to a high speed. In the acceleration portion, the acoustics of the vehicle are recorded as the vehicle accelerates along a track. In this way the acoustics of the exhaust muffler under simulated use conditions may be highlighted. Alternatively, various other recordings may be used.

By activating one of the plurality of input devices 44, a user can compare and contrast the various muffler exhaust sounds available for a given vehicle. Moreover, the PROM card 42 may be switched to provide a new set of vehicle muffler sounds. Due to the compact nature of the display 10 and its independent power source 58, the display 10 is portable and may be taken anywhere for use in various surroundings such as auto shows, conventions, repair shops, or retailers.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An apparatus for comparing muffler sounds comprising:
a controller storing a first muffler sound and a second muffler sound;
a first input device coupled to said controller;
a second input device coupled to said controller; and
an output device coupled to said controller, said output device emitting said first muffler sound when said first input device is activated, and said output device emitting said second muffler sound when said second input device is activated.

2. The apparatus of claim 1, wherein said controller comprises a circuit board and a computer chip, said first muffler sound and said second muffler sound stored digitally on said computer chip.

3. The apparatus of claim 2, wherein said circuit board is removable from said housing and a different circuit board having digitally stored muffler sounds may be mounted within said housing.

4. The apparatus of claim 2, wherein said first and second muffler sounds include a free rev portion wherein the sound of the muffler is recorded while the engine is allowed to rev and an acceleration portion wherein the sound of the muffler is recorded as the vehicle accelerates.

5. The apparatus of claim 2, wherein said circuit board further includes a signal amplifier coupled between said circuit chip and said output device.

6. The apparatus of claim 1, wherein said muffler sounds are prerecorded from different mufflers installed on the same type of vehicle.

7. The apparatus of claim 1, further comprising a volume control coupled to said controller for controlling the volume of said output device.

8. The apparatus of claim 1, wherein said first and second input devices are depressible button switches.

9. The apparatus of claim 1, wherein said output device is a speaker.

10. An acoustic countertop display comprising:
a housing adapted to sit on a countertop;
a controller mounted within said housing, said controller storing a plurality of prerecorded sounds;
a plurality of manually actuated button switches mounted on a surface of said housing and in communication with said controller, said button switches each associated with one of said plurality of prerecorded sounds; and
a speaker mounted within said housing and in communication with said controller;
wherein actuation of one of said plurality of button switches by a user orders said controller to send one of said prerecorded sounds associated with said one of said plurality of button switches to said speaker, said speaker emitting said prerecorded sound to said user.

11. The acoustic countertop display of claim 10, wherein said plurality of prerecorded sounds include the exhaust from various vehicle types having various muffler types.

12. The acoustic countertop display of claim 10, wherein said controller includes a Permanent Read-Only Memory (PROM) card, said PROM card digitally storing said prerecorded sounds, said PROM card removable from said housing by a user.

13. The acoustic countertop display of claim 10, wherein said housing includes a flat base adapted to rest on a countertop and a front face angled with respect to said flat base.

14. The acoustic countertop display of claim 13, wherein said plurality of button switches are mounted on said front face.

15. The acoustic countertop display of claim 14, further comprising a plurality of labels removably attached to said housing mounted proximate to said plurality of button switches on said front face.
